(19) United States
(12) Patent Application Publication
(10) Pub. No.: US 2026/0054795 A1
(43) Pub. Date: Feb. 26, 2026

(54) METHOD FOR ATTENUATING INTERFERENCE IN THE MEASUREMENT OF A TILT ANGLE OF A VEHICLE

(71) Applicant: SCHAEFFLER TECHNOLOGIES AG & CO. KG, Herzogenaurach (DE)

(72) Inventor: Jean-Luc FREMAUX, Escalquens (FR)

(73) Assignee: SCHAEFFLER TECHNOLOGIES AG & CO. KG, Herzogenaurach (DE)

(21) Appl. No.: 19/304,236

(22) Filed: Aug. 19, 2025

(30) Foreign Application Priority Data
Aug. 20, 2024 (FR) FR2408977

(51) Int. Cl. B62J 45/415; B62J 45/412; B62M 7/02; B62M 11/04; G01M 15/04; G01P 15/18

(52) U.S. Cl. CPC B62J 45/4151; B62J 45/412; B62M 7/02; B62M 11/04; G01M 15/046; G01P 15/18

(57) ABSTRACT

A method for attenuating interference in the measurement of an angle of sideways tilt of a motorized two-wheeled vehicle including an electronic control unit configured to compute an angle of sideways tilt of the vehicle from the measurements of a tilt sensor. The method includes: reception of the value of the speed of the vehicle measured by the speed-measuring module; reception of the number of revolutions per minute of the engine; computation of the ratio between the received speed value and the received number of revolutions per minute; comparison of the ratio between the received speed value and the number of revolutions per minute with an attenuation interval; if the ratio is outside the attenuation interval, computation of the tilt angle without attenuation; if the ratio is within the attenuation interval, computation of the tilt angle with attenuation.

### CROSS-REFERENCE TO RELATED APPLICATIONS

This application claims priority to French Application No. FR2408977, filed Aug. 20, 2024, the contents of such application being incorporated by reference herein.

### FIELD OF THE INVENTION

The present invention relates to the field of motorized two-wheeled vehicles and more particularly relates to measurement of the angle of sideways tilt of a motorized two-wheeled vehicle.

### BACKGROUND OF THE INVENTION

In order to improve driver safety, many motorized two-wheeled vehicles are currently equipped with systems which may act directly on the operation of the vehicle, without the intervention of the driver, as soon as a critical situation is detected.

It is known for manufacturers of motorized two-wheeled vehicles to include tilt sensors in their vehicles, these sensors in particular measuring the sideways tilt of the vehicle. These sensors are configured to have a maximum tilt threshold above which the vehicle is considered to be falling, triggering the engine to stop and thus making it possible to ensure the safety of the driver.

For example, if this threshold is 60° relative to a vertical direction defined by Earth's gravity, and the actual tilt angle of the vehicle is beyond 60°, the vehicle is considered to be falling and the engine is stopped.

This device also makes it possible to prevent the engine from starting if the vehicle is tilted beyond this threshold when the user attempts to start it up.

First-generation mechanical tilt sensors were attached to the chassis of the vehicle. These sensors contained weights (for example, balls) that, depending on the tilt of the vehicle, moved so as to close electrical contacts beyond a given tilt. The inertia of these weights thus determined the sensitivity of the sensor to the tilt of the vehicle and, moreover, the accuracy of the angle measurement.

However, these sensors were bulky and subject to significant constraints in respect of attachment to the chassis of the vehicle. For these reasons, a new generation of sensors consisting of an electronic control unit containing a MEMS accelerometer is now in use (MEMS standing for Micro-Electro-Mechanical System). This type of sensor may be mounted directly on the engine, on the intake manifold for example, or indeed mounted in proximity to the engine.

However, due to the proximity of the sensor to the engine, vibrations generated by the engine may affect the sensor and create interference in the measurement of tilt angle. The risk is then that this interference will cause the maximum tilt threshold to be artificially exceeded for a sufficient length of time that the electronic control unit interprets it as a fall, thus triggering the engine-stop function during normal operation of the vehicle.

This problem is compounded by the sampling of the measurements of tilt angle. Specifically, the interference related to the engine running is periodic. Therefore, if the sampling frequency is set regardless of the frequency of the interference (with respect to the Nyquist-Shannon sampling theorem) the reconstructed signal may have a longer period than that of the mechanical vibrations of the engine. This effect is known as aliasing and may therefore result in the maximum tilt threshold being artificially exceeded for a longer time, thus increasing the risk of the electronic control unit triggering stoppage of the engine.

One way of reducing the aliasing problem is to increase the sampling frequency used in the measurement of tilt angle, in order to capture the actual period of the interference. However, this solution is energy-intensive and places demands on the performance of the computer, which may become saturated, limiting its capacity to carry out more measurements and store them. In addition, it does not make it possible to prevent, even without aliasing, the vibrations of the engine from causing the tilt threshold to be exceeded artificially during the measurement of tilt angle.

There is therefore a need for a simple and effective solution which makes it possible to at least partly overcome these drawbacks.

### SUMMARY OF THE INVENTION

To this end, a first aspect of the invention relates to a method for attenuating interference in the measurement of an angle of sideways tilt of a motorized two-wheeled vehicle, said vehicle comprising an engine connected to a mechanical gearbox, an electronic control unit and a speed-measuring module, said electronic control unit comprising a tilt sensor and a memory region containing at least one predetermined attenuation interval, said electronic control unit being configured to compute the angle of sideways tilt of the vehicle from the measurements of the tilt sensor, to receive a value of the speed of the vehicle measured by the speed-measuring module and to receive the number of revolutions per minute of the engine, said method comprising the steps of:
reception, by the electronic control unit, of the value of the speed of the vehicle measured by the speed-measuring module,
reception, by the electronic control unit, of the number of revolutions per minute made by the engine,
computation, by the electronic control unit, of the ratio between the received speed value and the received number of revolutions per minute,
comparison, by the electronic control unit, of the ratio between the received speed value and the number of revolutions per minute with the at least one attenuation interval,
if the ratio between the received speed value and the number of revolutions per minute is outside the attenuation interval, computation, by the electronic control unit, of the tilt angle without attenuation,
if the ratio between the received speed value and the number of revolutions per minute is within the attenuation interval, computation, by the electronic control unit, of the tilt angle with attenuation.

The method according to an aspect of the invention thus makes it possible to attenuate the effect of engine vibrations on the determination of the angle of sideways tilt of the vehicle. When these vibrations are considered to be likely to cause interference in the measurement of the angle that could result in the tilt threshold being exceeded for long enough to trigger the stop function of the vehicle, the electronic control unit attenuates the components of the tilt sensor measurements that have the greatest impact on the measurement of tilt angle. Thus, the tilt angle remains representative of the physical tilt of the vehicle, but the vibrations are less likely to cause oscillations in the computed tilt angle (which could then cross the tilt threshold). When the ratio between the received speed value and the number of revolutions per minute is within the attenuation interval, the vehicle has a speed consistent with the engine speed and is therefore unlikely to be in the process of falling. Therefore, the attenuating method avoids false fall detection. In contrast, if the ratio between the received speed value and the number of revolutions per minute is outside this interval, there is an inconsistency that may mean a problem and it is therefore safer not to attenuate the signals so that the command to stop the engine may be sent as quickly as possible.

Preferably, the engine is connected to a mechanical gearbox and the step of reception, by the electronic control unit, of the number of revolutions per minute made by the engine, is followed by a step of determination of the engaged gear ratio of the gearbox. The gear ratio may be determined directly by sending signals from the gearbox to the electronic control unit, or indeed by computing the ratio between the measured speed and the number of revolutions per minute in the engine, and may be used to create redundancy in the verification of the conditions of application of the method according to an aspect of the invention.

Advantageously, if the electronic control unit receives from the gearbox that no gear ratio is engaged, the electronic control unit computes the tilt angle without attenuation, without performing the step of computation of the ratio between the received speed value and the received engaged gear ratio. In this case, the vibrations of the engine are minimal and therefore do not need to be attenuated. The engine may be running, for example if the vehicle is stationary and about to accelerate, and the measurement of the tilt angle of the vehicle is of relevance.

In one preferred embodiment, the speed-measuring module has in memory a reference speed value and the speed-measuring module sends this reference speed value to the electronic control unit in the event of failure of the speed-measuring module. The measurement of tilt angle and the method for attenuating the measurement may thus function even in the event of failure of the speed-measuring module.

In one embodiment of the invention, the tilt sensor is configured to determine the projection of Earth's gravity onto three axes, the electronic control unit is configured to compute the tilt angle from the three projections determined by the tilt sensor and the memory region contains at least one attenuation coefficient, and the step of computation of the tilt angle with attenuation corresponds to multiplication by the electronic control unit of at least one projection determined by the tilt sensor with the at least one attenuation coefficient. The attenuation may be applied to one of the projections measured by the tilt sensor. Thus, if one of the projections is determined to have no influence to the first order on the computation of the tilt angle, it is not necessary for the electronic control unit to attenuate this projection in the computation. The projections may for example be determined to have no influence to the first order through performance of a self-test by the electronic control unit, when it is able to apply modifications to the projection that do not or only slightly change the computed tilt angle.

Advantageously, in this embodiment, the memory region contains at least three attenuation coefficients, each corresponding to one projection axis and the step of computation of the tilt angle with attenuation corresponds to multiplication by the electronic control unit of each of the three projections determined by the tilt sensor with the corresponding attenuation coefficient. The attenuation may therefore be suitably applied to each of the three projections measured by the tilt sensor.

Also advantageously, the memory region contains at least one attenuation coefficient corresponding to each of the gear ratios of the gearbox of the vehicle and the step of computation of the tilt angle with attenuation corresponds to multiplication by the electronic control unit of at least one projection determined by the tilt sensor with the attenuation coefficient corresponding to the received gear ratio. A different attenuation is thus applied by the electronic control unit depending on the gear ratio engaged in the vehicle gearbox.

Preferably, in this embodiment, the memory region contains, for each of the gear ratios of the gearbox of the vehicle, three attenuation coefficients each corresponding to one projection axis and the step of computation of the tilt angle with attenuation corresponds to multiplication by the electronic control unit of each of the projections determined by the tilt sensor with the attenuation coefficient corresponding to the projection axis and to the received gear ratio. The attenuation is therefore tailored to the operation of the vehicle.

According to another aspect, the invention also relates to an electronic control unit for a motorized two-wheeled vehicle, said electronic control unit comprising a tilt sensor and a memory region, said memory region containing at least one attenuation interval and said electronic control unit being configured to be connected to a speed-measuring module and to the mechanical gearbox of the engine of said vehicle, said electronic control unit further being configured to:
receive a value of the speed of the vehicle measured by the speed-measuring module,
receive the gear ratio engaged in the gearbox,
compute the ratio between the received speed value and the received engaged gear ratio,
compare the ratio between the received speed value and the engaged gear ratio with the first threshold,
compute the tilt angle of the vehicle without attenuation,
compute the tilt angle of the vehicle with attenuation.

According to another aspect, the invention also relates to a motorized two-wheeled vehicle, comprising an engine connected to a gearbox, a speed-measuring module and an electronic control unit such as described.

### BRIEF DESCRIPTION OF THE DRAWINGS

Further features and advantages of aspects of the invention will become more clearly apparent on reading the following description. This description is purely illustrative and should be read with reference to the appended drawings, in which:

FIG. 1 schematically illustrates a motorized two-wheeled vehicle in which the method according to an aspect of the invention is applied.

FIG. 2 schematically illustrates an electronic control unit implementing the method.

FIG. 3 schematically illustrates the sideways tilt of the vehicle with respect to a tilt threshold triggering the engine-stop function.

FIG. 4 schematically illustrates the sequence of the method according to an aspect of the invention.

### DETAILED DESCRIPTION OF EXEMPLARY EMBODIMENTS

The method according to an aspect of the invention is applicable to a motorized two-wheeled vehicle 1.

### Vehicle 1

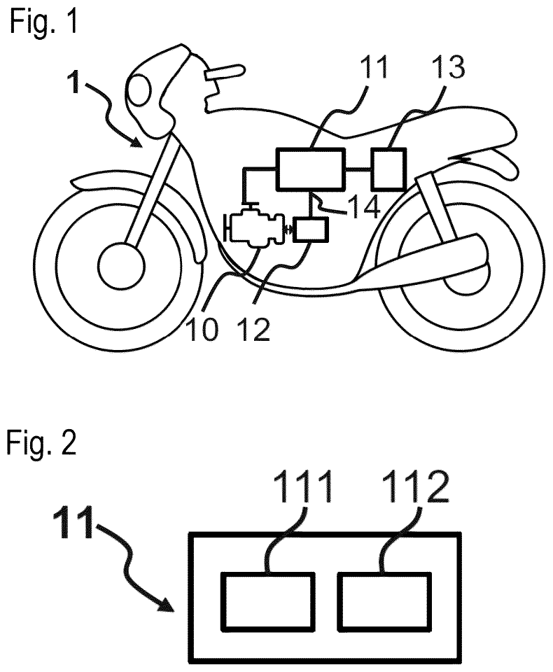

As shown in FIG. 1, the vehicle 1 comprises an engine 10, an electronic control unit 11, a mechanical gearbox 12, a speed-measuring module 13 and a communication link 14.

### Engine 10

The engine 10 makes it possible to produce the torque required to drive the wheels of the vehicle 1 when the vehicle is moving. This torque is delivered via rotation of a shaft, which rotates at a certain number of revolutions per minute, also known as the engine speed.

The engine 10 is connected to the gearbox 12.

The engine 10 may run without any gear of the mechanical gearbox 12 being engaged, for example when the vehicle 1 is started.

The gearbox 12 is used to transmit the engine speed to the wheels. Depending on the gear ratio engaged, the coefficient of proportionality between the engine speed and the wheel speed differs.

### Electronic Control Unit 11

As shown in FIG. 2, the electronic control unit 11 comprises a tilt sensor 111 and a memory region 112.

The tilt sensor 111 is preferably a MEMS accelerometer, configured to compute the projection of Earth's gravity onto three axes of a reference frame.

The electronic control unit 11 is configured to compute the angle of sideways tilt of the vehicle 1 with respect to Earth's vertical (Z-axis), from the three projections measured by the tilt sensor 111.

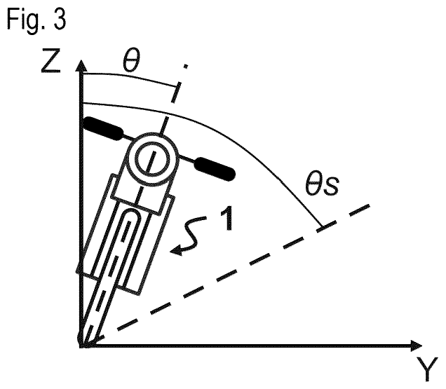

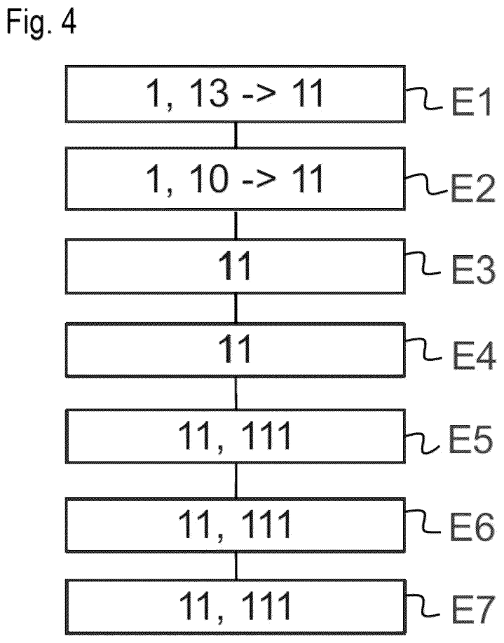

The memory region 112 is configured to store information. In particular, the memory region 112 contains an angle θs, corresponding to a tilt threshold beyond which the electronic control unit 11 considers the vehicle 1 to be in the process of falling, as shown in FIG. 3.

In FIG. 3, the Z-axis corresponds to Earth's vertical and the Y-axis corresponds to the horizontal direction perpendicular to the vehicle 1. The tilt angle is the angle made between the Y-axis and the vehicle 1.

The memory region 112 also contains at least one attenuation interval corresponding to ratios between the speed of the vehicle 1 and the number of revolutions per minute in the engine 10.

This interval corresponds to the values of this ratio under normal conditions of movement of a vehicle 1, especially when it is not falling.

The memory region 112 also contains a plurality of stored attenuation coefficients.

Preferably, the memory region 112 contains one coefficient for each of the three axes of the reference frame of the tilt sensor 111 and for each gear ratio of the gearbox 12.

Thus, for a vehicle 1 having a gearbox 12 comprising, for example, 5 gear ratios, the memory region 112 contains 15 coefficients.

Advantageously, the coefficients stored in the memory region 112 are less than or equal to 1.

The one or more attenuation coefficients may, in another form of embodiment, be low-pass filters that do not attenuate low frequencies (at which aliasing problems are less pronounced) but that attenuate high frequencies.

The electronic control unit 11 is configured to compute the tilt angle with attenuation by multiplying at least one projection measured by the tilt sensor 111 by the corresponding coefficient and to compute the tilt angle from this value.

The electronic control unit 11 is configured to compare the computed tilt angle with the tilt threshold θs.

The tilt threshold θs corresponds to the angle from which the electronic control unit 11 considers the vehicle 1 to be falling.

The electronic control unit 11 is configured to implement a function to stop the engine 10 of the vehicle 1 if the measured angle of sideways tilt is greater than the tilt threshold θs.

The electronic control unit 11 is configured to receive, via the communication link 14, the number of revolutions per minute of the engine 10.

The electronic control unit 11 is configured to receive, via the communication link 14, the gear ratio engaged in the gearbox 12 of the engine 10.

The electronic control unit 11 is also configured to determine the gear ratio engaged in the gearbox 12 of the engine 10 from the computation of the ratio between the speed of the vehicle 1 and the number of revolutions per minute of the engine 10.

The electronic control unit 11 is configured to receive, via the communication link 14, a value of the speed of the vehicle 1 measured by the speed-measuring module 13.

### Gearbox 12

The gearbox 12 has a number of gear ratios that allow the torque produced by the engine 10 to be matched to the performance desired by the user of the vehicle 1.

The gearbox 12 is mechanically connected to the engine 10 as shown in FIG. 1.

The gearbox 12 is configured to send to the electronic control unit 11, via the communication link 14, signals indicating which gear ratio is engaged or indeed whether no gear ratio is engaged.

### Speed-Measuring Module 13

The speed-measuring module 13 is configured to measure the speed of movement of the vehicle 1.

The speed-measuring module 13 may be of various types, such as a revolution counter on one of the wheels of the vehicle 1 for example.

### Communication Link 14

The communication link 14 allows communication between the electronic control unit 11 and the engine 10, the gearbox 12 and the speed-measuring module 13.

Preferably, the communication link 14 is a wired communication link, for example of CAN type.

### Example of Embodiment

When the vehicle 1 is moving, the engine 10 is running. The vibrations caused by the engine 10 running propagate to the electronic control unit 11 and are sensed by the tilt sensor 111.

The angle computed by the electronic control unit 11 from the measurements of the tilt sensor 111 therefore takes these vibrations into account.

The method according to an aspect of the invention aims to attenuate the impact of vibrations on the computation of the tilt angle in configurations where they are too great.

In a first step E1 of the method, the electronic control unit 11 receives a value of the speed of the vehicle 1 measured by the speed-measuring module 13.

In a second step E2, the electronic control unit 11 receives the number of revolutions per minute of the engine 10 and the gear ratio engaged in the gearbox 12. If, in this step, the electronic control unit 11 receives that no gear ratio is engaged, the method stops.

Specifically, this particular case indicates that the vehicle 1 is either stationary or is moving at a very low speed and without being driven by the engine 10, and hence there is no need to attenuate the effect of the vibrations.

It makes no difference whether steps E1 and E2 take place one after the other or simultaneously.

In a step E3, the electronic control unit 11 computes the ratio between the value of the speed received from the speed-measuring module 13 and the number of revolutions per minute of the engine 10.

In a step E4, the electronic control unit 11 compares the ratio thus computed with the attenuation interval stored in the memory region 112.

This interval corresponds to the expected operating points of the vehicle 1 under normal conditions. Under these conditions, the vehicle 1 is less likely to be tilted beyond the tilt-angle threshold θs, and it is therefore appropriate to attenuate the signals used to compute the tilt angle so as to prevent the electronic control unit 11 erroneously detecting a fall of the vehicle 1 and thus triggering the engine-stop function 10.

If the computed ratio is outside the attenuation interval, it is possible that the operating point of the vehicle 1 is such that there is a risk of a fall. In order not to falsely detect a fall, the electronic control unit 11 measures the tilt angle without attenuation in a step E5*, and the attenuating method restarts from step E1.

If the computed ratio is within the attenuation interval, the electronic control unit 11 detects that the vehicle 1 is unlikely to fall.

In this case, the electronic control unit 11 selects, in a step E5, the triplet of attenuation coefficients corresponding to the engaged gear ratio received in step E2 and stored in the memory region 112.

In a step E6, the electronic control unit 11 multiplies each of the three projections of the acceleration due to gravity determined by the tilt sensor 111 by the corresponding attenuation coefficient of the selected triplet.

In a step E7, the electronic control unit 11 computes the tilt angle from the three projections, each multiplied by the corresponding attenuation coefficient.

The attenuation thus applied makes it possible to counterbalance the effects of the vibrations of the engine 10 on the measurement of the tilt angle of the vehicle 1 by decreasing the value of the tilt angle computed when it is likely to oscillate beyond the tilt threshold under conditions where the vehicle 1 is unlikely to fall. The various attenuation coefficients for each gear ratio and each axis of the projection are determined beforehand, for example before the mass production of the vehicle 1 during tests for calibrating them.

Based on these tests, some coefficients may be determined to be equal to one, so as not to attenuate the corresponding projection if it is determined that it does not influence the computation of the physical tilt angle.

The method is reiterated as long as the engine 10 is running, so as to be able to adapt the attenuation depending on the gear ratio engaged and the speed of the vehicle 1.

For example, if the vehicle 1 is at a given time in a configuration where the angle measurement is attenuated and the user brakes, the vehicle 1 may slow down sufficiently for the region in which the ratio of the measured speed value to the number of revolutions per minute lies to be less than the attenuation interval. In this case, attenuation is no longer desirable, because the vehicle 1 is at a potentially risky operating point, and the electronic control unit 11 then computes the tilt angle from the measurements of the tilt sensor 111 without attenuation, so as not to falsely detect a fall.

1. A method for attenuating interference in the measurement of an angle of sideways tilt of a motorized two-wheeled vehicle, said vehicle comprising an engine, an electronic control unit and a speed-measuring module, said electronic control unit comprising a tilt sensor and a memory region containing at least one predetermined attenuation interval, said electronic control unit being configured to compute the angle of sideways tilt of the vehicle from the measurements of the tilt sensor, to receive a value of the speed of the vehicle measured by the speed-measuring module and to receive the number of revolutions per minute of the engine, said method comprising of:
reception, by the electronic control unit, of the value of the speed of the vehicle measured by the speed-measuring module,
reception, by the electronic control unit, of the number of revolutions per minute made by the engine,
computation, by the electronic control unit, of the ratio between the received speed value and the received number of revolutions per minute,
comparison, by the electronic control unit, of the ratio between the received speed value and the number of revolutions per minute with the at least one predetermined attenuation interval,
if the ratio between the received speed value and the number of revolutions per minute is outside the attenuation interval, computation, by the electronic control unit, of the tilt angle without attenuation,
if the ratio between the received speed value and the engaged gear ratio is within the attenuation interval, computation by the electronic control unit, of the tilt angle with attenuation.

2. The method as claimed in claim 1, wherein the engine is connected to a mechanical gearbox and wherein the step of reception, by the electronic control unit, of the number of revolutions per minute made by the engine, is followed by a step of determination of the engaged gear ratio of the gearbox.

3. The method as claimed in claim 2, wherein if the electronic control unit receives from the gearbox that no gear ratio is engaged, the electronic control unit computes the tilt angle without attenuation, without performing the step of computation of the ratio between the received speed value and the received engaged gear ratio.

4. The method as claimed in claim 1, wherein the speed-measuring module has in memory a reference speed value and wherein the speed-measuring module sends this reference speed value to the electronic control unit in the event of failure of the speed-measuring module

5. The method as claimed in claim 1, wherein the tilt sensor is configured to determine the projection of Earth's gravity onto three axes, the electronic control unit is configured to compute the tilt angle from the three projections determined by the tilt sensor and the memory region contains at least one attenuation coefficient, and wherein the step of computation of the tilt angle with attenuation corresponds to multiplication by the electronic control unit of at least one projection determined by the tilt sensor with the at least one attenuation coefficient.

6. The method as claimed in claim 5, wherein the memory region contains at least three attenuation coefficients, each corresponding to one projection axis and wherein the step of computation of the tilt angle with attenuation corresponds to multiplication by the electronic control unit of each of the three projections determined by the tilt sensor with the corresponding attenuation coefficient.

7. The method as claimed in claim 5, wherein the memory region contains at least one attenuation coefficient corresponding to each of the gear ratios of the gearbox of the vehicle and wherein the step of computation of the tilt angle with attenuation corresponds to multiplication by the electronic control unit of at least one projection determined by the tilt sensor with the attenuation coefficient corresponding to the received gear ratio.

8. The method as claimed in claim 5, wherein the memory region contains, for each of the gear ratios of the gearbox of the vehicle, three attenuation coefficients each corresponding to one projection axis and wherein the step of computation of the tilt angle with attenuation corresponds to multiplication by the electronic control unit of each of the projections determined by the tilt sensor with the attenuation coefficient corresponding to the projection axis and to the received gear ratio.

9. An electronic control unit for a motorized two-wheeled vehicle, said electronic control unit comprising a tilt sensor and a memory region, said memory region containing a predetermined attenuation interval and said electronic control unit being configured to be connected to a speed-measuring module and to the engine of said vehicle, said electronic control unit further being configured to:
receive a value of the speed of the vehicle measured by the speed-measuring module,
receive the number of revolutions per minute of the engine,
compute the ratio between the received speed value and the received number of revolutions per minute,
compare the ratio between the received speed value and the number of revolutions per minute with the attenuation interval,
compute the tilt angle of the vehicle without attenuation,
compute the tilt angle of the vehicle with attenuation.

10. A motorized two-wheeled vehicle, comprising an engine connected to a gearbox, a speed-measuring module and an electronic control unit as claimed in claim 9.

11. The method as claimed in claim 6, wherein the memory region contains at least one attenuation coefficient corresponding to each of the gear ratios of the gearbox of the vehicle and wherein the step of computation of the tilt angle with attenuation corresponds to multiplication by the electronic control unit of at least one projection determined by the tilt sensor with the attenuation coefficient corresponding to the received gear ratio.
